(19) United States
(12) Patent Application Publication
(10) Pub. No.: US 2020/0280344 A1
(43) Pub. Date: Sep. 3, 2020

(54) CELL GROUP OPTIMIZATION BY MEANS OF CANDIDATE ADVERTISING

(71) Applicants: Koninklijke KPN N.V., Rotterdam (NL); Nederlandse Organisatie Voor Toegepast-Natuurwetenschappelijk Onderzoek TNO, s-Gravenhage (NL)

(72) Inventors: Ljupco Jorguseski, Rijswijk (NL); Remco Litjens, Voorschoten (NL); Adrian Victor Pais, Voorburg (NL); Konstantinos Trichias, Athens (GR); Haibin Zhang, Voorburg (NL)

(21) Appl. No.: 16/472,815

(22) PCT Filed: Dec. 22, 2017
(86) PCT No.: PCT/EP2017/084307

§ 371 Date: Jun. 21, 2019

(30) Foreign Application Priority Data
Dec. 29, 2016 (EP) 16207268.0

(51) Int. Cl. H04B 7/024; H04W 48/20; H04W 24/02

(52) U.S. Cl. CPC H04B 7/024; H04W 24/02; H04W 48/20

(57) ABSTRACT

A system (1) is configured to select candidate sets of cell groups from a collection of sets of cell groups and arrange transmission of one or more messages to multiple mobile devices (11-15). The one or more messages specify at least one cell group per candidate set of cell groups for each of the mobile devices. The system is further configured to receive responses to the one or more messages. The responses comprise feedback from each of the mobile devices on the specified cell groups. The system is further configured to select one or more sets of cell groups from the candidate sets based on the received responses. A mobile device is configured to perform measurements on the specified cell groups after receipt of the one or more messages and to transmit the feedback in dependence on the measurements.

### RELATED APPLICATION(S)

This application is the U.S. National Stage of International Application No. PCT/EP2017/084307, filed Dec. 22, 2017, which designates the U.S., published in English, and claims priority under 35 U.S.C. § 119 or 365(c) to Europe Application No. 16207268.0, filed Dec. 29, 2016. The entire teachings of the above applications are incorporated herein by reference.

### FIELD OF THE INVENTION

The invention relates to a system for determining cell groups in a mobile communication network and a mobile device for transmitting feedback to a mobile communication network.

The invention further relates to a method of determining cell groups in a mobile communication network and a method of transmitting feedback to a mobile communication network.

The invention also relates to a computer program product enabling a computer system to perform any of such methods.

### BACKGROUND OF THE INVENTION

In order to increase the experienced bit rates of a mobile device by means of reducing their experienced interference and better utilizing the network wide available spectrum resources, such a single mobile device may be served by multiple cells from one or more base stations simultaneously. In LTE Coordinated MultiPoint (CoMP) transmission, operation of the multiple cells is coordinated so that network performance at the cell edges is improved. One possible coordination among the multiple cells from the same or different base stations is to create a virtual cell. The virtual cell may be used to cover a hot spot of traffic (i.e. an area with high concentration of mobile devices), for example. In CoMP, the network and the mobile devices are normally able to distinguish the multiple cells that are coordinated to serve the mobile devices as logically separated cells. When using virtual cells, the network and the mobile devices are normally not able to distinguish the cells cooperatively serving the mobile devices, i.e. they operate as logically one cell (and hence the term virtual cell).

A network administrator might be able to configure statically which cells and base stations cooperate, e.g. in a CoMP group or virtual cell, but this does not result in optimal resource usage. US 2012/0135766 A1 discloses a method for adaptive cell clustering. Measurement information is received from a plurality of cells. Each cell provides signal measurements based on the feedback of the devices they serve. Cell clusters are determined based on this measurement information and the cells are informed of the determined cell clusters, that they currently belong to.

A drawback of the method disclosed in US2012/0135766 is that only limited measurement information from the mobile devices is used, which results in selection of cell groups which lead to suboptimal mobile device, cell group and/or network performance.

### SUMMARY OF THE INVENTION

It is a first object of the invention to provide a system for determining cell groups in a mobile communication network, which helps achieve an improvement of performance.

It is a second object of the invention to provide a device for transmitting feedback to a mobile communication network, which allows cell groups to be determined that lead to an improvement of performance.

It is a third object of the invention to provide a method of determining cell groups in a mobile communication network, which helps achieve an improvement of performance.

It is a fourth object of the invention to provide a method of transmitting feedback to a mobile communication network, which allows cell groups to be determined that lead to an improvement of performance.

According to the invention, the first object is realized in that the system for determining cell groups in a mobile communication network comprises at least one processor configured to select a plurality of sets of cell groups from a collection of sets of cell groups, each set comprising a plurality of cell groups, each of said cell groups comprising at least one cell, at least one of said cell groups of each set comprising a plurality of cells, and said plurality of sets comprising less sets than said collection of sets, to arrange transmission of one or more messages to a plurality of mobile devices, said one or more messages specifying (also referred to as “advertising”) at least one cell group per set of cell groups of said plurality of sets of cell groups for each of said plurality of mobile devices, to receive responses to said one or more messages, said responses comprising feedback from each of said plurality of mobile devices on said specified cell groups, and to select one or more sets of cell groups from said plurality of sets based on said received responses.

The system may be a component of the mobile communication network, for example. The system may be a base station or a stand-alone network component of the mobile communication network, for example. The cell groups of a set are preferably disjoint, but alternatively, one or more cells may be part of multiple cell groups. Typically, a single base station serves mobile devices via multiple, e.g. three, cells. The plurality of sets of cell groups may be determined manually by a network planner or automatically based on initial, limited feedback from the mobile devices, for example. The at least one processor may select the one or more sets of cell groups from the plurality of sets by estimating performance indicator values, e.g. throughput, delay and/or error rate values, from the received responses and selecting the one or more sets of cells groups based on these network performance indicators. The performance indicator values may represent the performance of the network, of one or more mobile devices, and/or of one or more cell groups.

The inventors have recognized that if the mobile devices not only perform measurements on the cell to which they are attached, but also on one or more cells to which they are not attached, and this information is used to determine the cell groups, this helps achieve a better network performance. The inventors have further recognized that if the mobile devices would perform measurements on all the cells from which they are able to receive a signal and/or on all the cell groups that may be formed, transmitting these measurements would create too much overhead. By requesting feedback from each mobile device for certain candidate cell groups, the system can limit the overhead of too many measurements being transmitted by mobile devices, while at the same time an improved user, cell group and/or network performance is achieved.

Said plurality of sets cell groups may be deemed to lead to more optimal performance than non-selected sets of cell groups from said collection of sets of cell groups. More optimal performance may mean more optimal cell group performance, more optimal network performance and/or more optimal mobile device performance, for example. This allows the system to balance network performance and overhead by selecting the most promising candidate sets of cell groups, but limiting the amount of selected candidate sets of cell groups for which feedback is requested from the mobile devices.

At least one of said responses may comprise cell group channel state information of at least one of said specified cell groups and/or channel state information of each cell of at least one of said specified cell groups. At least one of said responses may comprise a selection from said specified cell groups.

Said at least one processor may be configured to select one set of cell groups from said plurality of sets of cell groups based on said received responses, to arrange transmission of one or more further messages to said plurality of mobile devices, said further messages instructing said mobile devices to participate in a cell group of said selected set of cell groups, and to control base stations to form said cell groups of said selected set of cell groups. After one of the sets of cell groups has been selected based on the responses, the base stations and mobile devices may be requested/arranged to form the cell groups of the selected set of cell groups. If the system is a base station, arranging the base stations to form the applicable cell groups of the selected set of cell groups may comprise configuring the base station in accordance with the cell groups of the selected set of cell groups and transmitting messages specifying the cell groups of the selected set of cell groups to other base stations corresponding to the cells in the cell groups.

Said at least one processor may be configured to arrange transmission of one or more further messages to said plurality of mobile devices, said one or more further messages specifying at least one cell group per selected set of cell groups for each of said plurality of mobile devices, to receive further responses to said one or more further messages, said further responses comprising feedback from each of said plurality of mobile devices on said specified cell groups, and to sub select one or more subsets of cell groups from said selected one or more sets of cell groups based on said received further responses. Before instructing/arranging the base stations and mobile devices to form cell groups of a set of cell groups, more detailed measurements on a subset of the one or more selected sets of cell groups may be requested from the mobile devices first. This gradual approach may help reduce the overhead of transmitting signal measurements.

According to the invention, the second object is realized in that the mobile device for transmitting feedback to a mobile communication network comprises a communication interface and at least one processor configured to use said communication interface to receive one or more messages from said mobile communication network, said one or more messages specifying a plurality of cell groups, to perform measurements on said plurality of cell groups and to use said communication interface to transmit said feedback in dependence on said measurements to said mobile communication network.

Said feedback may comprise channel state information of each cell of at least one of said specified cell groups. Alternatively or additionally, said feedback may comprise Cell group channel state information of at least one of said specified cell groups. Cell group channel state information is measured on all the cells of the cell groups at the same time and cannot be reconstructed from measurements on the individual cells. Cell group channel state information, e.g. a group precoding matrix indicator, provides a better indication of how a cell group will perform in practice than a combination of channel state information of the individual cells of the cell group.

Said feedback may comprise cell group channel state information of one of said specified cell groups, said one of said specified cell groups being deemed to be the best cell group by said mobile device. The best cell group may be the cell group determined by the mobile device to lead to optimal mobile device performance based on performance indicator values, e.g. throughput, error rate and/or delay values. Instead of transmitting cell group channel state information of multiple specified cell groups, the mobile devices may transmit only the cell group channel state information of the one cell group that they deem to be best. This may reduce transmission overhead and may allow the mobile devices to weigh in on the cell group determination.

Said channel state information may comprise a precoding matrix indicator, a channel quality indicator and/or a rank indicator. This channel state information provides more detailed/useful information than received signal strength information and is already determined by LTE compliant mobile devices, although only for the cells to which they are attached.

Said feedback may comprise a selection from said specified cell groups. Instead of transmitting one or more measurements, the mobile devices may simply identify which cell group(s) they deem to be the best. This may reduce transmission overhead and may allow the mobile devices to weigh in on the cell group determination.

According to the invention, the third object is realized in that the method of determining cell groups in a mobile communication network comprises selecting a plurality of sets of cell groups from a collection of sets of cell groups, each set comprising a plurality of cell groups, each of said cell groups comprising at least one cell, at least one of said cell groups of each set comprising a plurality of cells, and said plurality of sets comprising less sets than said collection of sets, arranging transmission of one or more messages to a plurality of mobile devices, said one or more messages specifying at least one cell group per set of cell groups of said plurality of sets of cell groups for each of said plurality of mobile devices, receiving responses to said one or more messages, said responses comprising feedback from each of said plurality of mobile devices on said specified cell groups, and selecting one or more sets of cell groups from said plurality of sets based on said received responses.

According to the invention, the fourth object is realized in that the method of transmitting feedback to a mobile communication network comprises receiving one or more messages from said mobile communication network, said one or more messages specifying a plurality of cell groups, performing measurements on said plurality of cell groups, and transmitting said feedback in dependence on said measurements to said mobile communication network.

Moreover, a computer program for carrying out the methods described herein, as well as a non-transitory computer readable storage-medium storing the computer program are provided. A computer program may, for example, be downloaded by or uploaded to an existing device or be stored upon manufacturing of these systems.

A non-transitory computer-readable storage medium stores at least one software code portion, the software code portion, when executed or processed by a computer, being configured to perform executable operations comprising: selecting a plurality of sets of cell groups from a collection of sets of cell groups, each set comprising a plurality of cell groups, each of said cell groups comprising at least one cell, at least one of said cell groups of each set comprising a plurality of cells, and said plurality of sets comprising less sets than said collection of sets, arranging transmission of one or more messages to a plurality of mobile devices, said one or more messages specifying at least one cell group per set of cell groups of said plurality of sets of cell groups for each of said plurality of mobile devices, receiving responses to said one or more messages, said responses comprising feedback from each of said plurality of mobile devices on said specified cell groups, and selecting one or more sets of cell groups from said plurality of sets based on said received responses.

The same or a different non-transitory computer-readable storage medium stores at least one further software code portion, the further software code portion, when executed or processed by a computer, being configured to perform executable operations comprising: receiving one or more messages from said mobile communication network, said one or more messages specifying a plurality of cell groups, performing measurements on said plurality of cell groups, and transmitting said feedback in dependence on said measurements to said mobile communication network.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the users computer, as a stand-alone software package, partly on the users computer and partly on a remote computer, or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system and device of the invention;

FIG. 2 depicts a first set of cell groups for the system and devices of FIG. 1;

FIG. 3 depicts a second set of cell groups for the system and devices of FIG. 1;

FIG. 4 is a flow diagram of a first embodiment of the methods of the invention;

FIG. 5 is a flow diagram of a second embodiment of the methods of the invention;

FIG. 6 shows a first example of a precoding matrix codebook;

FIG. 7 shows a second example of a precoding matrix codebook;

FIG. 8 is a block diagram of an exemplary cellular telecommunication system used in an embodiment of the device and the system of the invention; and

FIG. 9 is a block diagram of an exemplary data processing system for performing the methods of the invention.

Corresponding elements in the drawings are denoted by the same reference numeral.

### DETAILED DESCRIPTION OF THE DRAWINGS

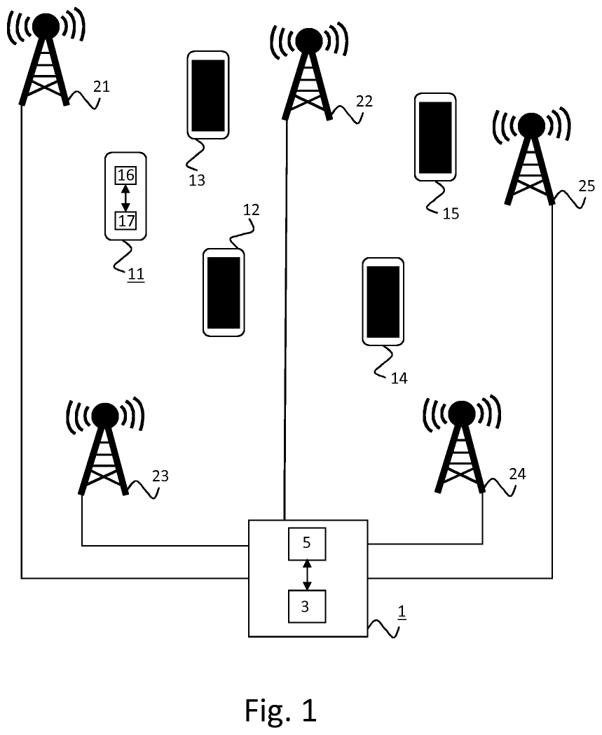

FIG. 1 shows a system 1, mobile devices 11 to 15 and base stations 21 to 25. The system 1 comprises a processor 3. The processor 3 is configured to select a plurality of (candidate) sets of cell groups from a collection of sets of cell groups. Each set comprises a plurality of cell groups and each of the cell groups comprises at least one cell. At least one of the cell groups of each set comprises a plurality of cells. The plurality (candidate) of sets comprises less sets than the collection of sets. The plurality of (candidate) sets cell groups is preferably deemed to lead to more optimal performance than non-selected sets of cell groups from the collection of sets of cell groups.

The processor 3 is further configured to arrange transmission of one or more messages to the plurality of mobile devices 11 to 15. The one or more messages specify/advertise at least one cell group per set of cell groups of the plurality of sets of cell groups for each of the plurality of mobile devices. The processor 3 is further configured to receive responses to the one or more messages. The responses comprise feedback from each of the plurality of mobile devices 11 to 15 on the specified cell groups. The processor 3 is further configured to select one or more sets of cell groups from the plurality of sets based on the received responses.

The mobile device 11 comprises a communication interface 16 and a processor 17. The processor 17 is configured to use the communication interface 16 to receive one or more messages from the mobile communication network. The one or more messages specify a plurality of cell groups. The processor 17 is further configured to perform measurements on the plurality of cell groups and to use the communication interface 16 to transmit the feedback in dependence on the measurements to the mobile communication network. The mobile devices 12 to 15 comprise a communication interface and a processor configured as described above (not shown in FIG. 1).

The feedback may comprise cell group channel state information of one of the specified cell groups, cell group channel state information of multiple of the specified cell groups or channel state information of each cell of at least one of the specified cell groups, for example. If the feedback comprises channel state information of only one of the specified cell groups, this cell groups is preferably deemed to be the best cell group by the mobile device. The channel state information may comprise a precoding matrix indicator, a channel quality indicator and/or a rank indicator. Alternatively or additionally, the feedback may comprise a selection from said specified cell groups, e.g. the one or more cell groups that are deemed to be the best cell groups by the mobile device.

In an embodiment, the processor 3 of the system 1 is configured to select one set of cell groups from the plurality of sets of cell groups based on the received responses and arrange transmission of one or more further messages to the plurality of mobile devices 11 to 15. The further messages instruct the mobile devices 11 to 15 to participate in a cell group of the selected set of cell groups. The processor 3 is further configured to control the base stations 21 to 25 to form the cell groups of the selected set of cell groups.

In an embodiment, the processor 3 of the system 1 is configured to arrange transmission of one or more further messages to the plurality of mobile devices 11 to 15. The one or more further messages specify at least one cell group per selected set of cell groups for each of the plurality of mobile devices 11 to 15. The processor 3 is further configured to receive further responses to the one or more further messages. The further responses comprise feedback from each of the plurality of mobile devices 11 to 15 on the specified cell groups. The processor 3 is further configured to sub select one or more subsets of cell groups from the selected one or more sets of cell groups based on the received further responses.

A mobile device may also be referred to by those skilled in the art as a mobile station (MS), a subscriber station, a mobile unit, a subscriber unit, a wireless unit, a wireless terminal, a wireless device, a wireless communications device, a remote device, a mobile subscriber station, an access terminal (AT), a mobile terminal, a user equipment (UE), a remote terminal, a handset, a terminal, a user agent, a mobile client, a client, or some other suitable terminology. Examples of a wireless terminal include a cellular phone, a smart phone, a session initiation protocol (SIP) phone, a laptop, a notebook, a netbook, a smartbook, a personal digital assistant (PDA), a tablet computer, a satellite radio, a global positioning system (GPS) device, a multimedia device, a video device, a digital audio player, a camera, a game console, or any other similar functioning device. A mobile device may have a slot for a UICC (also called a SIM card) or be provisioned with an embedded or enhanced version thereof for storage of credentials, for example. The base stations 21 to 25 may comprise, one or more LTE eNodeBs, for example.

In the embodiment shown in FIG. 1, the mobile device 11 comprises one processor 17. In an alternative embodiment, the mobile device 11 comprises multiple processors. In the embodiment shown in FIG. 1, the system 1 comprises one processor 3. In an alternative embodiment, the system 1 comprises multiple processors.

The communication interface 16 of the mobile device 11 may use WiFi, Ethernet or one or more cellular communication technologies such as GPRS, CDMA, UMTS and/or LTE to communicate with a base station, for example. The processor 17 may be a general-purpose processor, e.g. an ARM or a Qualcomm processor, or an application-specific processor. The processor 17 may be an Android or iOS operating system, for example. The mobile device 11 may comprise storage means (not shown), e.g. solid state memory. The mobile device 11 may comprise other components typical for a mobile device, e.g. a random access memory and a battery.

The processor 3 of the system 1 may be a general-purpose processor, e.g. an Intel or an AMD processor, or an application-specific processor, for example. The processor 3 may comprise multiple cores, for example. The processor 3 may run a Unix-based or Windows operating system, for example. The system 1 may comprise other components typical for a component in a mobile communication network, e.g. a power supply and a random access memory. The system 1 may comprise storage means (not shown). The storage means may comprise solid state memory, e.g. one or more Solid State Disks (SSDs) made out of Flash memory, or one or more hard disks, for example.

The communication interface 5 of the system 1 may be connected to the base stations 21 to 25 via a wired connection, for example. In the embodiment shown in FIG. 1, the system 1 is a single, stand-alone device. In another embodiment, the system 1 may comprise multiple devices and/or may be combined with another function in a mobile communication network, e.g. a base station. In another embodiment, the system 1 may comprise multiple base stations distributed over multiple sites, for example.

The operation of the system 1, mobile devices 11 to 15 and base stations 21 to 25 is explained with the help of an example. For the sake of this example, it is assumed that the five mobile devices 11 to 15 report the measured cells as is shown in Table 1 below. In this example, each cell corresponds to a single base station. Each mobile device reports back to the network which cells it can “hear” based on initial Reference Signal Received Power (RSRP) measurements. If a cell is “heard” by a mobile device with a RSRP which exceeds a certain threshold, then it is reported in its list.

TABLE 1

| Mobile Device | Reported Cells |
|---|---|
| 11 | 21, 22, 23 |
| 12 | 21, 22, 23 |
| 13 | 21, 22 |
| 14 | 22, 23, 24, 25 |
| 15 | 22, 25 |

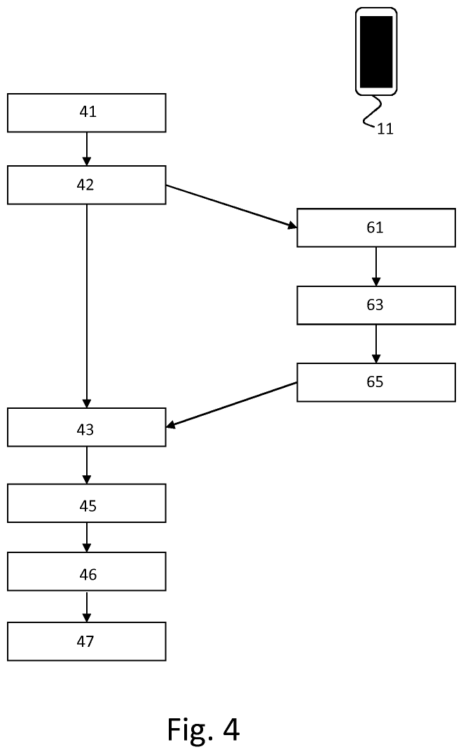

A flow diagram of a first embodiment of the methods of the invention is shown in FIG. 4. A step 41 comprises the system 1 selecting a plurality of sets of cell groups from a collection of sets of cell groups. Each set comprises a plurality of cell groups and each of the cell groups comprises at least one cell. At least one of the cell groups of each set comprises a plurality of cells. The plurality of sets comprises less sets than the collection of sets.

When applied to the afore-mentioned example, the method involves the system 1 determining how to group cells/base stations 21 to 25 for the mobile devices 11 to 15. The system 1 first determines a plurality of candidate sets of cell groups, e.g. from all possible sets of cell groups. The plurality of candidate sets of cell groups may be determined offline (i.e. before the cell grouping process starts), e.g. with a tool which decides based on historic data where and how to create the cell groups, or online (as part of the cell grouping process), e.g. based on initial feedback from the mobile devices. For example, the plurality of sets of cell groups may be determined online using the teachings of US2012/0135766. A candidate set of cell groups may include one or more cell groups comprising just a single macro-cell, which may create a virtual cell or not.

A candidate set of cell groups may comprise disjoint cell groups or at least some of the cell groups may overlap:

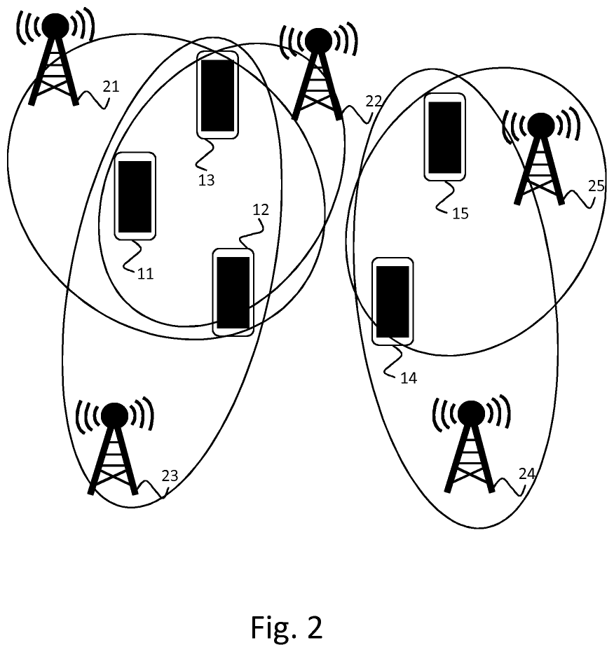

Disjoint cell groups: There is no one cell in the candidate set that participates in more than one cell group of the candidate set at the same time. For example, for the cells/base stations 21 to 25 of FIG. 1, two possible cell groups that could be generated in this way are, for example, cell group {21,22,23} and cell group {24,25}, see FIG. 2.

Overlapping cell groups: There are cells in the candidate set that participate in the formation of more than one cell groups of the candidate set and serve one or more mobile devices in all of the cell groups in which they participate. This allows more flexibility in the formation of cell groups, but may increase scheduling complexity. For example, for the cells/base stations 21 to 25 of FIG. 1, two possible cell groups that could be generated in this way are, for example, cell group {21,22,23} and cell group {22,24,25}. In this case, cell/base station 22 participates and serves users in both cell groups.

Each of the candidate sets of cell groups may comprise only disjoint cell groups, each of the candidate sets of cell groups may comprise at least some overlapping cell groups, or some of the candidate sets of cell groups may comprise only disjoint cell groups and other candidate sets of cell groups may comprise at least some overlapping cell groups. Furthermore, all cells in a cell group may serve all of the mobile devices in the cell group or one or more of the mobile devices in a cell group may be served by a subset of the cells in a cell group:

All cells in the cell group serve all of the UEs in the cell group: If this option is used, then cell groups have to be created in such sizes and configurations that all the participating cells in a cell group actively serve all the mobile devices belonging to that cell group. In the example of FIG. 2, in cell group {21, 22, 23} all three cells/base stations 21, 22 and 23 actively serve all mobile devices in that group, i.e. mobile devices 11, 12 and 13, and in cell group {24, 25} both cells/base stations 24 and 25 serve both mobile devices 14 and 15.

UEs in a cell group may be served by a subset of the cells of the cell group: If this option is used, then the definition of a cell group is more relaxed in the sense that not all cells participating in a cell group have to serve all mobile devices belonging to that cell group. Each mobile device belonging to such a cell group may be served by a subset of the cells that form that cell group. In the example of FIG. 2, in cell group {21, 22, 23}, mobile devices 11 and 12 may be served by all three cells/base stations (21, 22 and 23) while mobile device 13 may be served by only cells/base stations 21 and 22 (base station 23 might not serve mobile device 13, because the distance between them may be considered too large or there may be other causes that could render the transmission sub-optimal).

A step 42 comprises the system 1 arranging transmission of one or more messages to a plurality of mobile devices 11 to 15, e.g. via one or more of base stations 21 to 25. The one or more messages specify at least one cell group per set of cell groups of the plurality of sets of cell groups for each of the plurality of mobile devices.

A step 61 comprises the mobile device 11 receiving one or more messages from the mobile communication network. The one or more messages specify a plurality of cell groups. A step 63 comprises the mobile device 11 performing measurements on the plurality of cell groups specified in the received one or more messages. A step 65 comprises the mobile device 11 transmitting feedback in dependence on the measurements to the system 1, e.g. via one or more of base stations 21 to 25.

A new type of control signal may be defined with which the system 1 may inform the mobile devices 11 to 15 about the candidate cell groups and their configuration in a unicast or multicast way. This means that either each mobile device is individually (unicast) or jointly (multicast or broadcast) informed through this newly defined signal about the details of the advertised cell groups such as number of cell groups, cell IDs and which cell group each cell ID belongs to, and co-existing (non) overlapping cell groups. The new type of control message may be able to request feedback from mobile devices that are in an idle state.

The feedback of a mobile device may comprise its Channel State Information (CSI) with regard to one or more cell groups of each advertised candidate set, or at least the Precoding Matrix Indicator (PMI) with regard to these cell groups, but possibly additionally also the Rank Indicator (RI) and/or Channel Quality Indicator (CQI). The mobile device may give full or limited mobile device reporting of the PM's for the different candidate sets:

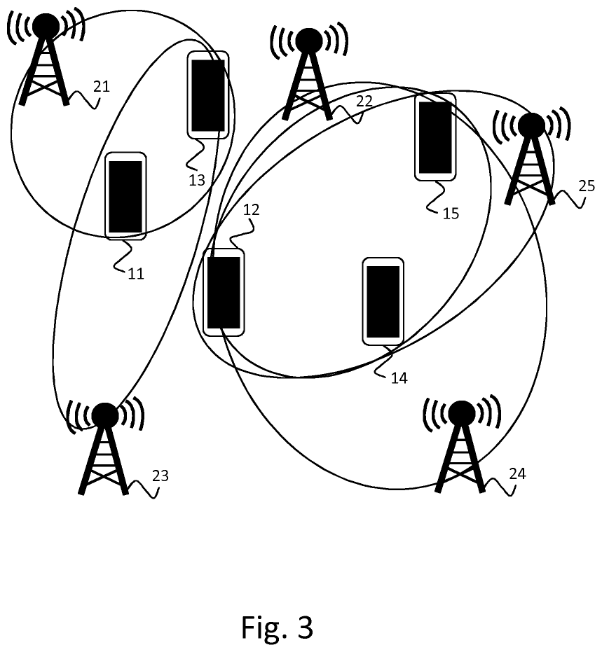

Full mobile device reporting means that the cell group-based PMIs for {21, 22, 23} and {24, 25} for candidate set 1 of FIG. 2 or those for {21, 23} and {22, 24, 25} for candidate set 2 of FIG. 3 are reported by all mobile devices, possibly accompanied by cell group-based CQI/RI reporting. If a mobile device cannot “hear” the cell, then it does not give PMI feedback for that cell by inserting zeros in the appropriate PMI matrix. The two candidate sets of FIGS. 2 and 3 require four group-based PMI reports (one for each cell group of candidate set 1 and one for each cell group of candidate set 2).

Limited mobile device reporting means that the mobile devices report only one cell group-based PMI for each advertised candidate set of cell groups, again possibly accompanied by cell group-based CQI/RI reporting. This one PMI may be fed back for only the dominant cell group, for example:
For each candidate set, report the PMI (and possibly CQI/RI) of the cell group that includes the cell with the strongest received RSRP. For example, if for mobile device 14, the cell/base station 24 is the one received with the strongest RSRP, then the mobile device 14 will only report the PMI for {24, 25} for candidate set 1 of FIG. 2 and the PMI for {22, 24, 25} for candidate set 2 of FIG. 3.
For each candidate set, report the PMI (and possibly CQI/RI) of the cell group that has highest sum of received RSRP. For example, if for mobile device 14 the cell/base station 24 is the one received with the strongest RSRP but the sum of cells/base stations 22 and 23 is higher, then the mobile device 14 will report the PMI for {21, 22, 23} for candidate set 1 (and not for {24, 25} where the strongest cell/base station 24 resides) and the PMI for {22, 24, 25} for candidate set 2.

Instead of giving limited or full mobile device reporting for each candidate set, the mobile device may give limited or full mobile device reporting only for the candidate set deemed most optimal by the mobile device. Instead of providing Channel State Information as feedback, the mobile device may just identify which candidate set or which cell group of which candidate set is deemed most optimal by the mobile device.

Mobile devices may report PMIs for individual cells separately or a joint PMI for all the cells in a cell group. In the example of FIG. 2, mobile device 11 may report PMIs for individual cells (cells/base stations 21, 22, 23) separately or a joint PMI for all the cells in the cell group {21, 22, 23}.

In case of separate reporting, mobile device 11 reports its selected PMIA, PMIB, and PMIC for the transmission from cells/base stations 21, 22 and 23 separately, corresponding to the selected precoding vector FNt-21, FNt-22, FNt-23, where Nt-21, Nt-22 and Nt-23 refers to the number of transmit antennas at cells/base stations 21, 22 and 23, respectively. In the case, for instance, that each cell has two transmit antennas, the mobile devices report 3 PMIs (a.k.a. 3 vectors) of size two (i.e. two elements in each vector).

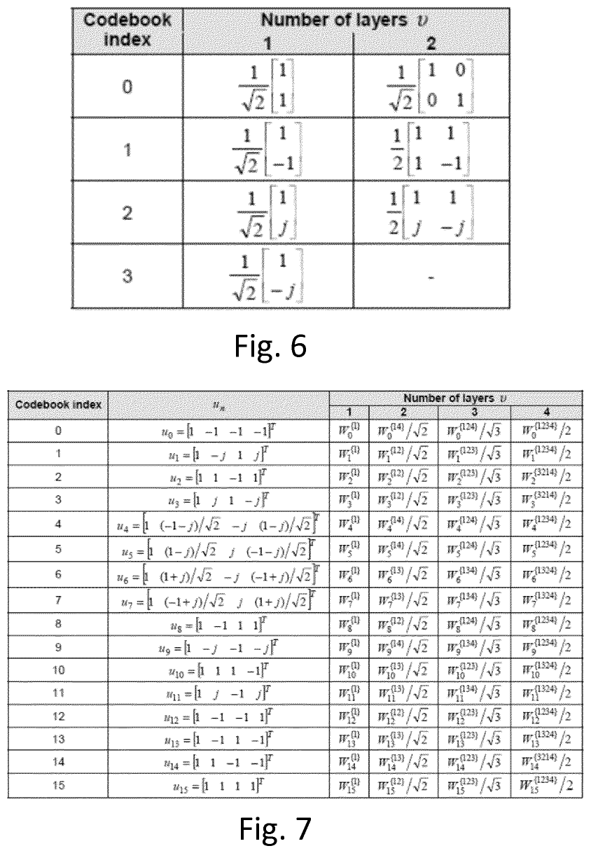

A PMI is chosen from a codebook. As known, a mobile device may report a preferred PMI, or a codebook index number as shown in FIG. 6 and FIG. 7, to the radio access network for indicating which set of antenna configuration parameters are preferably used by the radio access network for transmission. When a mobile device reports a PMI to a base station it may be able to indicate a preference for the use of more than one layer if the base station has at least two transmission antennas and the mobile device has at least two receive antennas. If the mobile device prefers the use of more than one layer, it reports a codebook index representing a matrix instead of a vector as shown for two layers in FIG. 6 and for two to four layers FIG. 7.

In summary, each mobile device selects a vector FNt (with size Nt×n, n being the number of preferred transmission layers) from all possible precoding matrixes, which maximizes the throughput of the mobile device (all possible pre-coding matrixes are typically a priori known to the mobile devices). The column FNt is reported by the mobile device to the network using a so-called precoding matrix index (PMI), which indicates which of the columns of all the possible precoding matrixes is selected by the mobile device. The size of FNt depends on the number of transmit antennas Nt and the number of preferred transmissions layers (also referred to as “rank” and represented by a Rank Indication).

FIG. 6 shows a codebook as defined in the LTE/LTE-Advanced standard for an antenna system having two antenna ports (and therefore specifying maximum two layers). The codebook contains seven sets of antenna configuration parameters (seven matrices Wₙ). FIG. 7 shows a codebook as defined by the LTE/LTE-Advanced standard for transmission using four antenna ports. Matrix Wₙ can be determined from FIG. 7 by using the vector uₙ listed in the second column of the codebook according to the formula Wₙ₌I−2uₙuₙ^{H}/uₙ^{H}uₙ. Wₙ^{(v)} comprises v columns of the matrix Wn multiplied by a certain factor, as shown in the third to sixth column of the codebook. For example, W₀⁽¹⁾ corresponds to parameter set [0.5 0.5 0.5 0.5]. The superscript “(1)” in “Woo)” indicates the first column of matrix W₀.

The mobile device may determine the throughput when the base station would use a certain precoding matrix by first determining a SNR for the certain precoding matrix by using, for example, equation (5) of the paper “Calculation of the spatial preprocessing and link adaption feedback for 3GPP UMTS/LTE”, Schwarz et al., 6th Conference on Wireless Advanced (WiAD), 27-29 Jun. 2010.

The SNR may be calculated for each precoding matrix using the same channel matrix H. From each SNR value a throughput value may be calculated. Fig. 4 of “TBS and MCS Signaling and Tables”, Motorola submission R1-081638 at 3GPP TSG RAN1 #52bis, Shenzhen, China, Mar. 31-Apr. 4 2008, provides an example of how to map SNR to Modulation Coding Scheme (MCS) index.

In LTE, a Transport Block Size (TBS) index may be determined from the MCS index using Table 7.1.7.1-1 of 3GPP TS 36.213 V12.5.0 (2015-03), for example. The throughput also depends on the number or Resource Blocks (RBs) assigned to the mobile device. From the TBS index and the number of RBs, the TBS (in bits per millisecond) can be determined using Table 7.1.7.2.1-1 of 3GPP TS 36.213 V12.5.0 (2015-03), for example. To get the throughput per second, the TBS should be multiplied by 1000 and if 2-layer MIMO transmission is used, further multiplied by two. For example, in case 100 available RBs are assigned to the mobile device (possible for LTE system bandwidth of 20 MHz), an MCS Index of 28 means a TBS Index of 26, and a TBS index of 26 and 100 RBs means a TBS of 75376 bits per millisecond. Using 2-layer MIMO transmission, this results in a throughput of 150.752 Mbps.

In case of joint PMI reporting, mobile device 11 reports its selected PMI{21,22,23}, for joint transmission from cells/base stations 21, 22 and 23, corresponding to the selected column FNt-21+Nt-22+Nt-23. In the case of two transmit antennas per cell, the mobile device would transmit one PMI of size six (i.e. one vector with six elements). The selection in this case happens from a different codebook of pre-coding matrixes where each one-layer pre-coding vector has a size of six elements, e.g. a codebook for transmission using six antenna ports (3×2 antenna ports in this case). In this case, the channel matrix H that is used for determining the SNR for each precoding matrix is a concatenation of the channel matrices H determined with respect to each of the three cells/base stations.

In principle, the selected vector FNt-21+Nt-22+Nt-23 is not necessarily the same as the concatenation of FNt-21, FNt-22, and FNt-23. That means, that the PMI{21,22,23} cannot necessarily be constructed at the network side by utilizing the individual PMIs, i.e. PMI21, PMI22 and PMI23. For instance, mobile device 11 may report a separate PMI for cell/base station 21 (PMI21), a separate PMI for cell/base station 22 (PMI22) and a separate PMI for cell/base station 23 (PMI23) instead of reporting a common ‘cell group-based PMI’ for the cell group {21,22,23} (PMI{21,22,23}). However, by configuring the base stations of a cell group for a certain mobile device based on the cell group PMI provided by that certain mobile device, beamforming gain may increase, and as a result, throughput may increase.

For example, if a mobile device would report, in a cell-specific CSI feedback, PMI21 referring to FNt-21,2×2 and PMI22 referring to Fnt-22,2×2 for individual cells 21 and 22 (the ‘2×2’ refers that a constellation of 2 transmit antennas in each of the cells, and 2 receive antennas in the mobile device), then the simple concatenation of the indicated precoding matrices FNt-21,22,4×2=[[FNt21,2×2]^{T}; [FNt22,2×2]^{T}]^{T} does not need to be the ‘4×2’ precoding matrix that best serves the mobile device when jointly served by cells/base stations 21 and 22. In particular, the columns of FNt-21,22,4×2 may not be orthogonal, which would reduce the rank (i.e. the dimension of the vector space spanned by its columns) of the precoding matrix.

As another example, it may very well be that the mobile device reports FNt-21,2×1 with RI21=1 for cell/base station 21, and FNt-22,2×2 with RI22=2 for cell/base station 22, in which case the ranks are different and first the rank RI21,22 of a joint cell ‘21+22’ transmission would need to be determined and the concatenation of the two cell-specific precoding matrices may again likely not be a correspondingly optimal precoding matrix for the joint cell ‘21+22’ transmission. Hence there is indeed a benefit in requesting mobile device feedback for the cell groups, rather than for individual cells only.

Mobile devices may thus be able to be configured to report, with varying level of detail, on a different number of cells belonging to their own or different cell groups. Moreover, the mobile devices may be able to understand the cell group assignment and treat the antennas of the different cells of the group as different (distributed) antennas of the same transmission point, in order to create a single PMI for reporting for that cell group.

A step 43 comprises the system 1 receiving the responses to the one or more messages. The responses comprise feedback from each of the plurality of mobile devices on the specified cell groups. A step 45 comprises the system 1 selecting one set of cell groups from the plurality of sets based on the received responses.

Based on the received feedback per candidate set of cell groups, the system 1 may estimate the overall throughput (downlink or uplink), or other metrics, for the five mobile devices 11 to 15 and select the candidate set that is deemed most optimal. This may be done as follows:
1. For each candidate set and each reported cell group of the candidate set, the system 1 may estimate the achievable throughput for each mobile device for the situation where the mobile device would be served by the cell group of the candidate set based on the feedback (e.g. based on the PMI and possibly CQI/RI). The system 1 may be configured to determine from PMI feedback if, based on the orthogonality conditions, more than one mobile device (in multi user MIMO fashion) can be served simultaneously by a cell group.
2. By adding the estimated metric per mobile device, the system 1 may select the candidate set of cell groups that is deemed most optimal based on a number of different possible metrics, e.g. highest aggregated average throughput, highest cell edge throughput, minimum scheduling complexity, or better performance for users with priority (e.g. service level agreements). When making this selection, the system 1 may assume that each mobile device will use, after the set of cells has been selected, the cell group that it has deemed to be most optimal for them.

The system 1 may determine the throughput from CQI and RI feedback, for example. The MCS index may be determined from the CQI using Table 7.2.3-1 of 3GPP TS 36.213 V12.5.0 (2015-03), for example. An MCS index and an amount of resource blocks that meet the modulation scheme requirement and code rate requirement (listed in this table) corresponding to the indicated CQI may then be selected. With this MCS index and number of resource blocks, the throughput may be calculated from the MCS index and number of resource blocks, as explained previously in relation the determination of throughput from the SNR.

The system 1 may determine from a group PMI whether the mobile device that has transmitted the PMI was able to hear each of the cells in the candidate cell group. When a mobile device is not able to hear a certain cell, the values corresponding to this cell are normally zero in the PMI transmitted by the mobile device. This information may be taken into account in this step 45. This determination from the group PMI prevents that the mobile device needs to communicate separately which cells it is able to hear. If a mobile device is able to hear a certain cell, but does not prefer it for some reason (e.g. the cell is ‘heard’ barely over the RSRP threshold), it may be able to set the values corresponding to this certain cell to zero in the group PMI that it transmits. This information may be used by the network to decide the kind of cell groups to be used, meaning whether all the cells in a cell group will be serving all the mobile devices in that cell group or whether the use of sub-sets of cells will be allowed in order to serve some mobile devices in certain cell groups.

The system 1 may determine from PMI feedback if based on the orthogonality conditions, more than one mobile device (in MU-MIMO fashion) can be served simultaneously by a cell group. This leads to a higher spectral efficiency. If a mobile device prefers the use of more than one layer (e.g. provides a rank indication of 2), the system 1 may also determine whether the columns of the precoding matrix indicated by the mobile device are orthogonal and use this information in step 45. Use of a precoding matrix with orthogonal columns leads to a higher spectral efficiency and may therefore be taken into account in this step 45. Preferably, this PMI is a group PMI, because, apart from the advantages mentioned earlier, the use of group PM's may increase beamforming gain when the selected groups have been formed, and as a result, throughput may increase.

A step 46 comprises arranging transmission of one or more further messages to the plurality of mobile devices 11 to 15. The further messages instruct the mobile devices 11 to 15 to participate in a cell group of the selected set of cell groups. A step 47 comprises controlling the base stations 21 to 25 to form the cell groups of the selected set of cell groups. If one or more PM's were received from one or more of the mobile devices 11 to 15 in step 43, the PM's are preferably provided to one or more of the base stations 21 to 25 in step 47 to avoid that they need to obtain them from the mobile devices in their cell groups separately. After the selected groups have been formed, the mobile devices 11 to 15 will send updated feedback, e.g. CSI reports, to the base stations 21 to 25 as part of their normal operation. This updated feedback may also include updated group PMIs.

The cells in a cell group may cooperate in an LTE coordinated multipoint (CoMP) transmission scheme or in any other type of scheme that requires the cooperation among different eNBs/transmission points/RRHs, for example, and in which a decision among various alternative cooperating sets needs to be taken. Such schemes may be virtual cells, virtual/vertical sectorization, eICIC, eMBMS/SFN, for example.

There are many criteria that could be used to select the cell group(s) leading to optimal performance in step 45 and assign mobile devices to the selected cell groups after step 45 has been performed. A few examples are listed below:
Assignment based on maximum RSRP: Assign each mobile device to the cell group which contains the cell towards which the mobile device experiences the largest RSRP. In the case of Table 1 and FIG. 2 for instance, mobile device 11 and 12 would be assigned to cell group {21, 22, 23} since they both experience their strongest RSRP towards cell/base station 21.
Assignment based on maximum average RSRP: Assign each mobile device to the cell group that provides that mobile device with the maximum average RSRP, where the average RSRP is calculated over all the cells belonging to each cell group. In the case of FIG. 2 for instance, the average RSRP of all mobile devices would be calculated for cell groups {21, 22, 23} and {24, 25} and each mobile device would be assigned to the cell group that provided it with the strongest average RSRP.
Assignment based on estimated maximum throughput: Assign each mobile device to the cell group that will result in the mobile device experiencing maximum throughput. The network could make estimations (based on the initially reported feedback of each mobile device) about what kind of performance (in terms of throughput) each mobile device will experience in the different cell groups, and assign the mobile devices to the cell groups that maximize each mobile device's throughput.

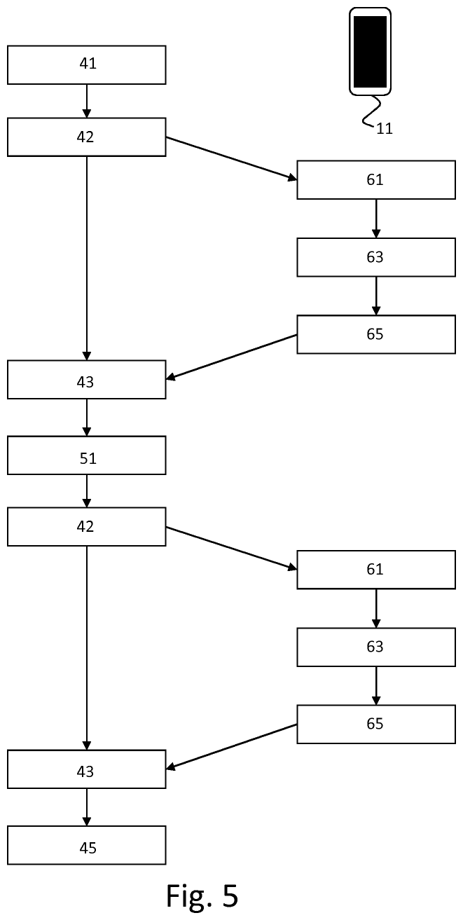

In the second embodiment of the methods of the invention shown in FIG. 5, a step 51 is performed after step 43 instead of step 45. Step 51 comprises selecting multiple sets of cell groups from the plurality of sets based on the received responses. Step 42 is performed again after step 51, but now, the one or more messages specify at least one cell group per set of cell groups of the sets of cell groups selected in step 51 for each of the plurality of mobile devices 11 to 15. Next, steps 61, 63, 65 and 43 are repeated. Step 45 is performed after step 43. Step 45 comprises the system 1 selecting one set of cell groups based on the received responses from the sets selected in step 51.

In other words, the embodiment of FIG. 5 uses a gradual approach in which the candidate advertising is done in two steps, e.g. a first round of candidate advertising based on initial raw measurement (e.g. RSRP only) for a larger amount of candidate sets and then a second round of candidate advertising based on more elaborate feedback (e.g. PMI, CQI, RI) from the mobile devices for a smaller amount of candidate sets. In the embodiment of FIG. 4, the candidate advertising is done in one step.

In the second embodiment of the methods of the invention shown in FIG. 5, steps 46 of 47 of FIG. 1 have been omitted. In an extension of the second embodiments, steps 46 and 47 are performed after step 45.

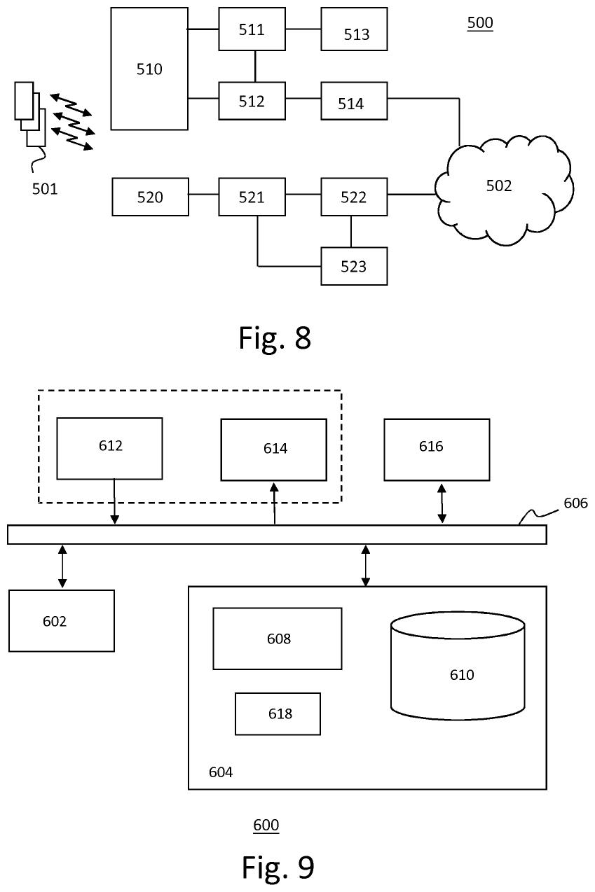

In the telecommunications system 500 of FIG. 8, three generations of networks are schematically depicted together for purposes of brevity. A more detailed description of the architecture and overview can be found in 3GPP Technical Specification TS 23.002 ‘Network Architecture’ which is included in the present application by reference in its entirety. Other types of cellular telecommunication system can alternatively or additionally be used, e.g. a 5G cellular telecommunication system.

The lower branch of FIG. 8 represents a GSM/GPRS or UMTS network.

For a GSM/GPRS network, a radio access network (RAN) system 520 comprises a plurality of nodes, including base stations (combination of a BSC and a BTS), not shown individually in FIG. 8. The core network system comprises a Gateway GPRS Support Node 522 (GGSN), a Serving GPRS Support Node 521 (SGSN, for GPRS) or Mobile Switching Centre (MSC, for GSM, not shown in FIG. 8) and a Home Location Register 523 (HLR). The HLR 523 contains subscription information for user devices 501, e.g. mobile stations MS.

For a UMTS radio access network (UTRAN), the radio access network system 520 also comprises a Radio Network Controller (RNC) connected to a plurality of base stations (NodeBs), also not shown individually in FIG. 8. In the core network system, the GGSN 522 and the SGSN 521/MSC are connected to the HLR 523 that contains subscription information of the user devices 501, e.g. user equipment UE.

The upper branch of the telecommunications system in FIG. 8 represents a next generation network, commonly indicated as Long Term Evolution (LTE) system or Evolved Packet System (EPS).

The radio access network system 510 (E-UTRAN), comprises base stations (evolved NodeBs, eNodeBs or eNBs), not shown individually in FIG. 8, providing cellular wireless access for a user device 501, e.g. user equipment UE. The core network system comprises a PDN Gateway (P-GW) 514 and a Serving Gateway 512 (S-GW). The E-UTRAN 510 of the EPS is connected to the S-GW 512 via a packet network. The S-GW 512 is connected to a Home Subscriber Server HSS 513 and a Mobility Management Entity MME 511 for signalling purposes. The HSS 513 includes a subscription profile repository SPR for user devices 501.

For GPRS, UMTS and LTE systems, the core network system is generally connected to a further packet network 502, e.g. the Internet.

Further information of the general architecture of an EPS network can be found in 3GPP Technical Specification TS 23.401 ‘GPRS enhancements for Evolved Universal Terrestrial Radio Access Network (E-UTRAN) access’.

FIG. 9 depicts a block diagram illustrating an exemplary data processing system that may perform the methods as described with reference to FIGS. 4 and 5.

As shown in FIG. 9, the data processing system 600 may include at least one processor 602 coupled to memory elements 604 through a system bus 606. As such, the data processing system may store program code within memory elements 604. Further, the processor 602 may execute the program code accessed from the memory elements 604 via a system bus 606. In one aspect, the data processing system may be implemented as a computer that is suitable for storing and/or executing program code. It should be appreciated, however, that the data processing system 600 may be implemented in the form of any system including a processor and a memory that is capable of performing the functions described within this specification.

The memory elements 604 may include one or more physical memory devices such as, for example, local memory 608 and one or more bulk storage devices 610. The local memory may refer to random access memory or other non-persistent memory device(s) generally used during actual execution of the program code. A bulk storage device may be implemented as a hard drive or other persistent data storage device. The processing system 600 may also include one or more cache memories (not shown) that provide temporary storage of at least some program code in order to reduce the number of times program code must be retrieved from the bulk storage device 610 during execution.

Input/output (I/O) devices depicted as an input device 612 and an output device 614 optionally can be coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 612 and the output device 614). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 616 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 600, and a data transmitter for transmitting data from the data processing system 600 to said systems, devices and/or networks. Modems, cable modems, and Ethernet cards are examples of different types of network adapter that may be used with the data processing system 600.

As pictured in FIG. 9, the memory elements 604 may store an application 618. In various embodiments, the application 618 may be stored in the local memory 608, the one or more bulk storage devices 610, or separate from the local memory and the bulk storage devices. It should be appreciated that the data processing system 600 may further execute an operating system (not shown in FIG. 9) that can facilitate execution of the application 618. The application 618, being implemented in the form of executable program code, can be executed by the data processing system 600, e.g., by the processor 602. Responsive to executing the application, the data processing system 600 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 602 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A system for determining cell groups in a mobile communication network, comprising at least one processor configured to:
select a plurality of sets of cell groups from a collection of sets of cell groups, each set comprising a plurality of cell groups, each of said cell groups comprising at least one cell, at least one of said cell groups of each set comprising a plurality of cells, and said plurality of sets comprising less sets than said collection of sets,
arrange transmission of one or more messages to a plurality of mobile devices, said one or more messages specifying at least one cell group per set of cell groups of said plurality of sets of cell groups for each of said plurality of mobile devices,
receive responses to said one or more messages, said responses comprising feedback from each of said plurality of mobile devices on said specified cell groups, and
select one or more sets of cell groups from said plurality of sets based on said received responses.

2. A system as claimed in claim 1, wherein at least one of said responses comprises cell group channel state information of at least one of said specified cell groups and/or channel state information of each cell of at least one of said specified cell groups.

3. A system as claimed in claim 1, wherein at least one of said responses comprises a selection from said specified cell groups.

4. A system as claimed in claim 1, wherein said plurality of sets cell groups is deemed to lead to more optimal performance than non-selected sets of cell groups from said collection of sets of cell groups.

5. A system as claimed in claim 1, wherein said at least one processor is configured to:
select one set of cell groups from said plurality of sets of cell groups based on said received responses,
arrange transmission of one or more further messages to said plurality of mobile devices, said further messages instructing said mobile devices to participate in a cell group of said selected set of cell groups, and
control base stations to form said cell groups of said selected set of cell groups.

6. A system as claimed in claim 1, wherein said at least one processor is configured to:
arrange transmission of one or more further messages to said plurality of mobile devices, said one or more further messages specifying at least one cell group per selected set of cell groups for each of said plurality of mobile devices,
receive further responses to said one or more further messages, said further responses comprising feedback from each of said plurality of mobile devices on said specified cell groups, and
sub select one or more subsets of cell groups from said selected one or more sets of cell groups based on said received further responses.

7. A mobile device for transmitting feedback to a mobile communication network, comprising:
a communication interface; and
at least one processor configured to use said communication interface to receive one or more messages from said mobile communication network, said one or more messages specifying a plurality of cell groups, to perform measurements on said plurality of cell groups and to use said communication interface to transmit said feedback in dependence on said measurements to said mobile communication network.

8. A mobile device as claimed in claim 7, wherein said feedback comprises cell group channel state information of at least one of said specified cell groups.

9. A mobile device as claimed in claim 8, wherein said feedback comprises cell group channel state information of one of said specified cell groups, said one of said specified cell groups being deemed to be the best cell group by said mobile device.

10. A mobile device as claimed in claim 7, wherein said feedback comprises channel state information of each cell of at least one of said specified cell groups.

11. A mobile device as claimed in claim 8, wherein said channel state information comprises a precoding matrix indicator, a channel quality indicator and/or a rank indicator.

12. A mobile device as claimed in claim 7, wherein said feedback comprises a selection from said specified cell groups.

13. A method of determining cell groups in a mobile communication network, comprising:
selecting a plurality of sets of cell groups from a collection of sets of cell groups, each set comprising a plurality of cell groups, each of said cell groups comprising at least one cell, at least one of said cell groups of each set comprising a plurality of cells, and said plurality of sets comprising less sets than said collection of sets;
arranging transmission of one or more messages to a plurality of mobile devices, said one or more messages specifying at least one cell group per set of cell groups of said plurality of sets of cell groups for each of said plurality of mobile devices;
receiving responses to said one or more messages, said responses comprising feedback from each of said plurality of mobile devices on said specified cell groups; and
selecting one or more sets of cell groups from said plurality of sets based on said received responses.

14. A method of transmitting feedback to a mobile communication network, comprising:
receiving one or more messages from said mobile communication network, said one or more messages specifying a plurality of cell groups;
performing measurements on said plurality of cell groups; and
transmitting said feedback in dependence on said measurements to said mobile communication network.

15. A computer program or suite of computer programs comprising at least one software code portion or a computer program product storing at least one software code portion, the software code portion, when run on a computer system, being configured for performing the method of claim 13.
